(19) United States
(12) Patent Application Publication
(10) Pub. No.: US 2026/0047735 A1
(43) Pub. Date: Feb. 19, 2026

(54) CLEANING ROBOT CAPABLE OF RECOGNIZING FLOOR TYPE

(71) Applicant: PIXART IMAGING INC., Hsin-Chu County (TW)

(72) Inventors: Guo-Zhen WANG, Hsin-Chu County (TW); Mian-Jhong CHIU, Hsin-Chu County (TW)

(21) Appl. No.: 18/801,760

(22) Filed: Aug. 13, 2024

(51) Int. Cl. A47L 9/28; A47L 9/30; A47L 11/40; G01S 7/481; G01S 17/894

(52) U.S. Cl. CPC A47L 9/2826; A47L 9/2842; A47L 9/30; A47L 11/4002; A47L 11/4011; G01S 7/4815; G01S 17/894; A47L 2201/06

(57) ABSTRACT

There is provided a cleaning robot including a first optical detection path, a second optical detection path and a processor. The first optical detection path is used to distinguish a flat floor and a carpet with short hairs using the dark field effect. The second optical detection path is used to detect a carpet with long hairs and/or a length of carpet hairs. The processor controls the cleaning robot to perform different application functions according to the recognized type of a working surface.

### FIELD OF THE DISCLOSURE

This disclosure generally relates to a cleaning robot and, more particularly, to a cleaning robot and a floor type recognition method that are able to recognize a flat floor, a carpet with short hairs and a carpet with long hairs.

### BACKGROUND OF THE DISCLOSURE

The cleaning robot has been improved from having the conventional sweeping function to having a mopping function. Accordingly, as long as a cleaning robot is able to accurately distinguish the floor type, it is possible to adjust a corresponding suction force, to remove a wiping component and to adjust a height of the wiping component.

For example, while operating on a flat floor, the cleaning robot operates in a normal suction force. However, while running on a carpet, the cleaning robot increases the suction force in order to have a better cleaning performance, and in the meantime the height of a wiping component is increased or the wiping component is automatically removed from the main body.

Nowadays, there are some products that use ultrasonics to recognize a carpet and a flat floor. However, due to the physical limitation of the ultrasonics, it is not able to accurately distinguish a carpet with short hairs from a flat floor. In addition, the cleaning robot is further required to recognize a carpet with long hairs in some scenarios. If a carpet type cannot be recognized, some functions of the cleaning robot cannot be operated normally.

The information disclosed in this BACKGROUND is merely intended to increase understanding of the general background of the invention and should not be taken as an admission or in any way implied that the relevant information constitutes prior art that is already known to a person of ordinary skill in the art.

### SUMMARY

Accordingly, the present disclosure provides a cleaning robot and a floor type recognition method thereof that use different detecting means to recognize a flat floor, a carpet with short hairs and a carpet with long hairs.

The present disclosure further provides a cleaning robot and a floor type recognition method thereof that use a dark field effect to recognize a flat floor and a carpet with short hairs, and use multiple light sources or multiple light sensors to identify a carpet with long hairs.

The present disclosure provides a cleaning robot for recognizing a type of a working surface and including a first light source, a second light source and an image sensor. The first light source is configured to illuminate the working surface using a main projection light beam to form a main reflected light beam. The second light source is configured to project a linear light section toward the working surface. The image sensor is not arranged on the main reflected light beam, and is configured to receive scattered light of the main projection light beam illuminating the working surface to output a first image frame, and acquire a second image frame containing a light section image of the linear light section of the second light source.

The present disclosure further provides a cleaning robot for recognizing a type of a working surface and including a light source, an image sensor and a time-of-flight sensor. The light source is configured to illuminate the working surface using a main projection light beam to form a main reflected light beam. The image sensor is not arranged on the main reflected light beam, and is configured to receive scattered light of the main projection light beam illuminating the working surface to output an image frame. The time-of-flight sensor is configured to measure a distant from the working surface.

The present disclosure further provides a cleaning robot for recognizing a type of a working surface and including a first light source, a reflection surface, a second light source and an image sensor. The first light source is configured to illuminate the working surface using a main projection light beam to form a main reflected light beam. The second light source is configured to illuminate the reflection surface toward a direction parallel to the working surface. The image sensor is not arranged on the main reflected light beam, and is configured to receive scattered light of the main projection light beam illuminating the working surface to output a first image frame, and receive reflected light of the reflection surface that reflects an emission light beam of the second light source to output a second image frame.

### BRIEF DESCRIPTION OF DRAWINGS

Other objects, advantages, and novel features of the present disclosure will become more apparent from the following detailed description when taken in conjunction with the accompanying drawings.

FIG. 1A is a schematic diagram of lighting a first light source of a cleaning robot according to a first embodiment of the present disclosure.

FIG. 1B is a schematic diagram of lighting a second light source of a cleaning robot according to a first embodiment of the present disclosure.

FIG. 2A is a descriptive table of a floor type recognition method of a cleaning robot according to a first embodiment of the present disclosure.

FIG. 2B is a schematic diagram of light section images in an image frame acquired by a cleaning robot according to a first embodiment of the present disclosure.

FIG. 3 is a schematic diagram of a cleaning robot according to a second embodiment of the present disclosure.

FIG. 4A is a schematic diagram of lighting a first light source of a cleaning robot according to a third embodiment of the present disclosure.

FIG. 4B is a schematic diagram of lighting a second light source of a cleaning robot according to a third embodiment of the present disclosure.

FIG. 5 is a schematic diagram of arranging a first light source on a bottom cover of a cleaning robot according to an embodiment of the present disclosure.

FIG. 6 is a bottom view of a cleaning robot according to an embodiment of the present disclosure.

### DETAILED DESCRIPTION OF THE DISCLOSURE

It should be noted that, wherever possible, the same reference numbers will be used throughout the drawings to refer to the same or like parts.

One objective of the present disclosure is to provide a cleaning robot capable of recognizing a flat floor (e.g., including a ceramic tile floor, a wood floor and a marble floor, but not limited to), a carpet with short hairs and a carpet with long hairs by arranging multiple light sources or multiple light sensors. In this way, the cleaning robot is able to execute different cleaning functions corresponding to different types of a working surface, and these cleaning functions are determined according to the equipped devices thereof without particular limitations. For example, after receiving an identification result made by a processor 13 (described below) of a sensor chip/module of the present disclosure, the micro controller unit (MCU) or a central processing unit (CPU) of the cleaning robot controls the cleaning robot to perform corresponding functions.

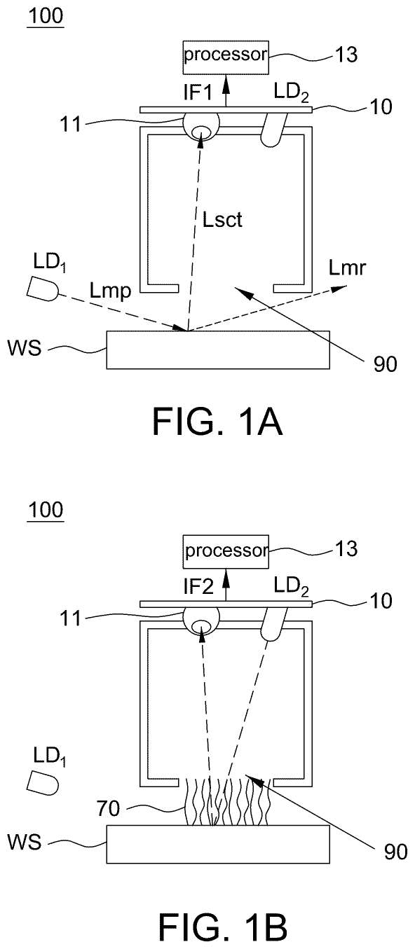

Please refer to FIGS. 1A and 1B, FIG. 1A is a schematic diagram of lighting a first light source LD1 of a cleaning robot 100 according to a first embodiment of the present disclosure; and FIG. 1B is a schematic diagram of lighting a second light source LD2 of a cleaning robot 100 according to a first embodiment of the present disclosure. The cleaning robot 100 is able to recognize a type of a working surface Ws on which the cleaning robot 100 operates.

The cleaning robot 100 includes a first light source LD1, a second light source LD2, a substrate 10, an image sensor 11 and a processor 13.

The first light source LD1 is used to illuminate the working surface WS using a main projection light beam Lmp to form a main reflected light beam Lmr, wherein the main projection light beam Lmp and the main reflected light beam Lmr are light beams symmetrical to a normal line of the working surface WS.

The second light source LD2 is used to project a linear light section toward the working surface WS. For example, the second light source LD2 includes a laser light source and a diffractive optical element (DOE), which causes emission light emitted by the laser light source to generate the linear light section after passing therethrough.

The substrate 10 is, for example, a printed circuit board (PCB) or a flexible board without particular limitations. In one aspect, the second light source LD2 and the image sensor 11 are disposed on the substrate 10, but not limited to.

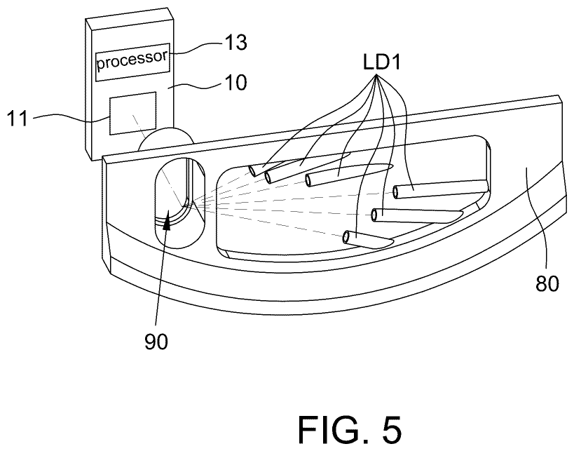

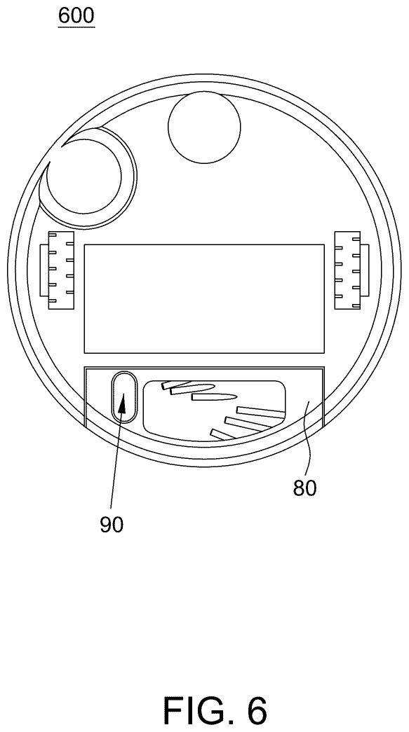

The cleaning robot 100 further includes a bottom cover 80 (e.g., referring to FIG. 5), which is attached to a bottom of the cleaning robot 100, e.g., referring to FIG. 6. The bottom cover 80 is arranged, for example, at a side of the cleaning robot 100 close to a moving direction of the cleaning robot 100 such that the cleaning robot 100 firstly detects a type of the working surface WS before a cleaning device (e.g., sweeping and wiping components) thereof enters a different working surface. In one aspect, the first light source LD1 is arranged on the bottom cover 80.

In one aspect, the bottom cover 80 includes a through hole 90 and a bottom surface connecting to the through hole 90. The substrate 10 is arranged inside the through hole 90 (e.g., referring to FIG. 5) to allow the second light source LD2 to project the linear light section to the working surface WS via the through hole 90 and allow the image sensor 11 to receive scattered light Lsct of the main projection light beam Lmp illuminating the working surface WS and to capture reflected light of the linear light section. The first light source LD1 is arranged on the bottom surface outside the through hole 90. As shown in FIG. 5, the first light source LD1 may be arranged at different positions from the through hole 90. It should be mentioned that the multiple first light sources LD1 shown in FIG. 5 are to indicate that the first light source LD1 may be arranged at different positions but not to indicate that the cleaning robot 100 includes multiple first light source LD1. In the present disclosure, the cleaning robot 100 may include a single first light source LD1.

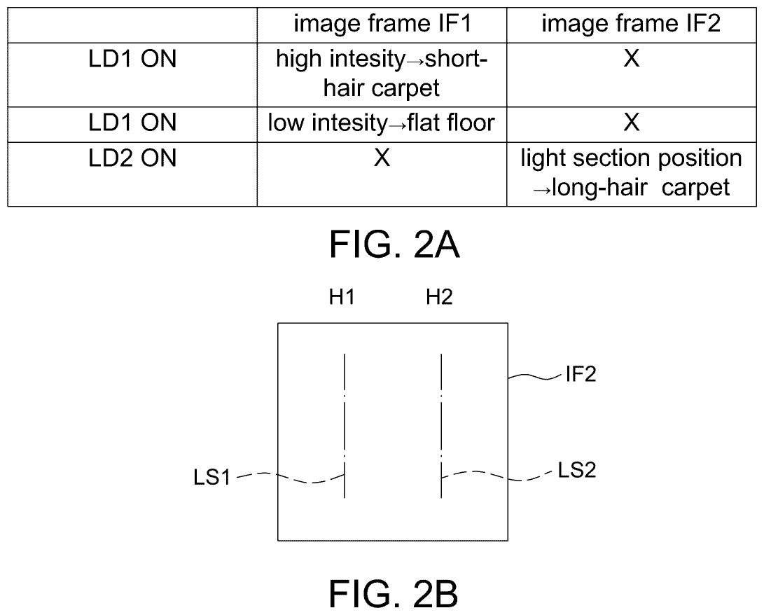

The image sensor 11 is, for example, complementary metal-oxide-semiconductor (CMOS) image sensor or a charge-coupled device (CCD) image sensor. In the present disclosure, the image sensor 11 is not arranged on the main reflected light beam Lmr of the first light source LD1 so as to perform the detection based on the dark field effect. The image sensor 11 receives the scattered light Lsct generated from the working surface WS when the working surface WS is illuminated by the main projection light beam Lmp of the first light source LD1 to output a first image frame IF1, and acquires a second image frame IF2 containing a light section image (e.g., LS1 and LS2 shown in FIG. 2B) of the linear light section of the second light source LD2.

The processor 13 is a digital signal processor (DSP), an application specific integrated circuit (ASIC) or a field programmable gate array (FPGA). The processor 13 is coupled to the first light source LD1 and the second light source LD2 to control ON/OFF thereof, and is coupled to the image sensor 11 to receive the first image frame IF1 and the second image frame IF2. In the first embodiment, the processor 13 recognizes the working surface WS as a flat floor or a carpet with short hairs according to the first image frame IF1, and recognizes whether the working surface WS is a carpet with long hairs or not according to the second image frame IF2, e.g., the carpet with long hairs being identified when a length of hairs 70 (referring to FIG. 1B) of a carpet is longer than a predetermined length. In one aspect, the processor 13 further outputs the detected length of hairs 70 to the MCU or CPU of the cleaning robot 100 for corresponding controls/processes. The processor 13 implements operations thereof using hardware, firmware and/or software.

For example referring to FIG. 2A, the processor 13 identifies that the working surface WS is a carpet with short hairs when an average brightness of the first image frame IF1 exceeds a brightness threshold (e.g., shown as high intensity), and identifies that the working surface WS is a flat floor when the average brightness of the first image frame IF1 is lower than the brightness threshold (e.g., shown as low intensity).

The cleaning robot 100 further includes, for example, a memory (not shown) that records the relationship between different positions of the light section image in the second image frame IF2 with respect to different distances. For example referring to FIG. 2B, a light section image LS1 is corresponding to a first height H1 (or first hair length) of the working surface WS, and a light section image LS2 is corresponding to a second height H2 (or second hair length) of the working surface WS. The processor 13 obtains a current distance from the working surface WS according to a current position of the light section (e.g., positions of LS1 or LS2) and the relationship (i.e. using triangulation ranging) to identify whether the working surface WS is a carpet with long hairs or not. To use the triangulation ranging, the second light source LD2 preferably projects the linear light section with a tilted angle with respect to the normal line of the working surface WS.

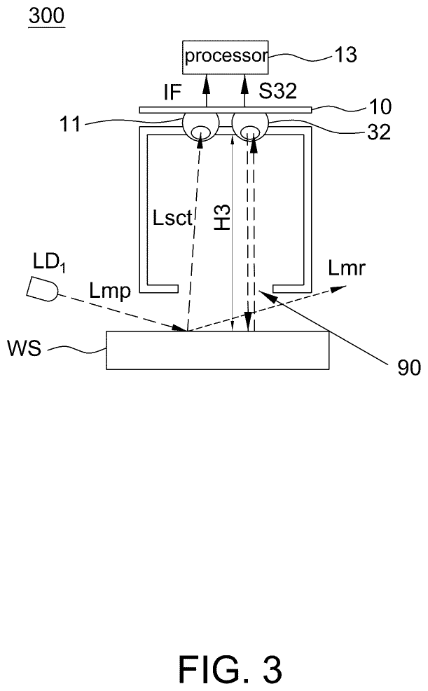

Please refer to FIG. 3, it is a schematic diagram of a cleaning robot 300 according to a second embodiment of the present disclosure. The cleaning robot 300 is also able to recognize a type of a working surface WS on which the cleaning robot 300 operates. The cleaning robot 300 also includes a light source LD1, a substrate 10, an image sensor 11 and a processor 13, which are respectively identical to those in the first embodiment having identical reference numerals. In the second embodiment, the light source LD1 is used to illuminate the working surface WS using a main projection light beam Lmp to form a main reflected light beam Lmr. The image sensor 11 is not arranged on the main reflected light beam Lmr, and is used to receive scattered light Lsct generated by the main projection light beam Lmp illuminating the working surface WS to output an image frame IF. The image sensor 11 is arranged on the substrate 10 and the light source LD1 is arranged on the bottom cover 80, which are identical to the first embodiment and thus details thereof are not repeated herein.

The difference between the second embodiment and the first embodiment is that the second embodiment further includes a time-of-flight (ToF) sensor 32 for measuring a distance from the working surface WS to replace the second light source LD2. The Tof sensor 32 is, for example, a single photon avalanche diode (SPAD) based direct Tof sensor or indirect ToF sensor without particular limitations. The method to measure a distance by the time-of-flight is known to the art, and thus details thereof are not described herein. In one aspect, the ToF sensor 32 and the image sensor 11 are arranged on the substrate 10, and are opposite to the working surface WS via a through whole 90. In the second embodiment, the ToF sensor 32 and the image sensor 11 operate simultaneously or time-divisionally without particular limitations.

In the second embodiment, the processor 13 recognizes the working surface WS as a flat floor or a carpet with short hairs according to the image frame IF, which is identical to that described in the first embodiment (e.g., referring to FIG. 2A), and thus details thereof are not repeated herein. The processor 13 further identifies that the working surface WS as a carpet with long hairs when a distance H3 detected by the ToF sensor 32 is smaller than a distance threshold, which means the carpet hairs enter the through hole 90.

In one aspect, the processor 13 further outputs the distance H3 measured by the ToF sensor 32 to the MCU or CPU of the cleaning robot 300 for corresponding controls/processes.

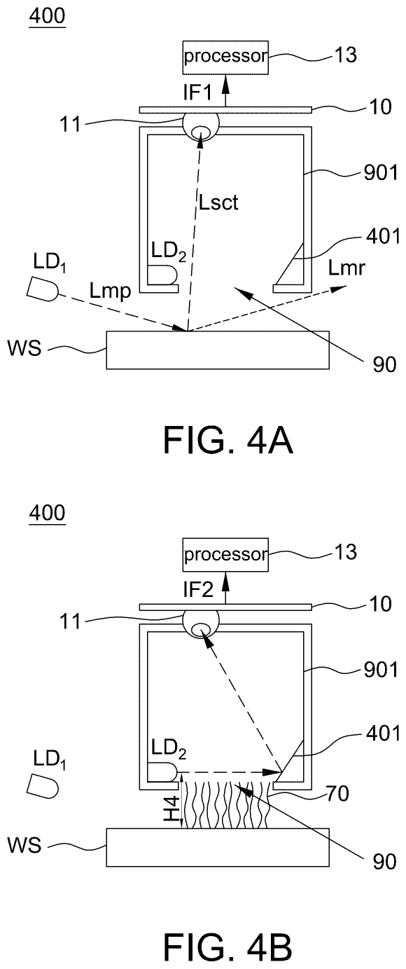

Please refer to FIGS. 4A and 4B, FIG. 4A is a schematic diagram of lighting a first light source LD1 of a cleaning robot 400 according to a third embodiment of the present disclosure; and FIG. 4B is a schematic diagram of lighting a second light source LD2 of a cleaning robot 400 according to a third embodiment of the present disclosure. The cleaning robot 400 is also able to recognize a type of a working surface WS on which the working surface WS operates.

The cleaning robot 400 also includes a first light source LD1, a second light source LD2, a substrate 10, an image sensor 11 and a processor 13. The difference between the third embodiment and the first embodiment is that the second light source LD2 is arranged at a different position in the third embodiment, and the second light source LD2 projects a linear light source or not without particular limitations.

Similarly, the first light source LD1 is used to illuminate the working surface WS using a main projection light beam Lmp to form a main reflected light beam Lmr. The image sensor 11 is not arranged on the main reflected light beam Lmr, and is used to receive scattered light Lsct of the main projection light beam Lmp illuminating the working surface WS to output a first image frame IF1.

The second light source LD2 is used to illuminate a reflection surface 401 toward a direction parallel to the working surface WS, e.g., a transverse direction as shown in FIG. 4B. The image sensor 11 further receives reflected light of the reflection surface 401 that reflects an emission light beam of the second light source LD2 to output a second image frame IF2.

In the third embodiment, the first light source LD1 is arranged on a bottom surface outside the through hole 90, referring to FIGS. 5 and 6. The second light source LD2 is arranged at a first side on an inner wall 901 of the through hole 90 (e.g., at a height H4), and the reflection surface 401 is arranged at a second side, opposite to the first side, on the inner wall 901 of the through hole 90. The reflection surface 401 is arranged with a tilted angle to reflect an optical path of the second light source LD2 toward the image sensor 11.

The substrate 100 is arranged inside the through hole 90. The image sensor 11 is arranged on the substrate 10, but the second light source LD2 is not arranged on the substrate 10.

In the third embodiment, the processor 13 recognizes the working surface WS as a flat floor or a carpet with short hairs according to the first image frame IF1, which has been illustrated in the first embodiment (e.g., referring to FIG. 2A) and thus details thereof are not described again.

The processor 13 further recognizes whether the working surface WS is a carpet with long hairs. For example, when carpet hairs 70 block a transverse optical path of the second light source LD2, the image sensor 11 is not able to receive light energy from the reflection surface 401. Therefore, the third embodiment is arranged in the way that when an average brightness of the second image frame IF2 is lower than a brightness threshold, the processor 13 identifies the working surface Ws as a carpet with long hairs, indicating the optical path of the second light source LD2 being blocked. The length of carpet hairs to distinguish a carpet with long hairs is defined by a height (e.g., H4) of the second light source LDs being arranged.

The third embodiment may be combined with the second embodiment to form an alternative embodiment. For example, the LD2 in FIGS. 4A and 4B is replaced by the ToF sensor 32 to measure a distance from another side of the inner wall 901 of the through hole 90, i.e. the reflection surface 401 being removed. When the carpet hairs 70 are longer than the height H4, the ToF sensor 32 measures a shorter distance and thus a carpet with long hairs is recognized.

In another alternative embodiment, the LD2 in FIGS. 4A and 4B is arranged above the reflection surface 401 (e.g., arranged on the substrate 10 with the image sensor 11), and the position originally arranged with the LD2 is replaced by another reflection surface such that a projection light beam from the LD2 arranged above the reflection surface 401 is received by the image sensor 11 after being reflected twice. That is, this alternative embodiment is to form a transverse light beam between two reflection surfaces at a height H4 for detecting whether the carpet hairs 70 enter the through hole 90 or not.

In another alternative embodiment, the LD2 in FIGS. 4A and 4B is arranged to project a longitudinal (i.e. extending direction of hairs) linear light section on the inner wall 901 (without reflection surface 401), and a field of view of the image sensor 11 covers the longitudinal light section. In this way, the processor 13 identifies a length of carpet hairs 70 and recognizes a carpet with long hairs according to a length variation of a light section image of the longitudinal light section in the second image frame IF2. The processor 13 may output the detected length signal to the MCU or CPU of the cleaning robot for corresponding controls/processes.

It should be mentioned that although the drawings of the present disclosure show light sources by LD1 and LD2, the light sources of the present disclosure are not limited to laser diodes. The light sources of the present disclosure may be light emitting diodes (LED).

As mentioned above, to allow a cleaning robot to be able to perform different functions correctly, how to accurately recognize a type of working surfaces is an important requirement. However, the present ultrasonic means to recognize a working surface is not able to accurately distinguish a flat floor and a carpet with short hairs. In addition, there is still an issue that a carpet with long hairs cannot be recognized. Accordingly, the present disclosure further provides a cleaning robot (e.g., referring to FIGS. 1A-1B, 3 and 4A-4B) that uses a first optical detection path to distinguish a flat floor and a carpet with short hairs based on the dark field effect, and uses a second optical detection path to detect a carpet with long hairs and/or a length of carpet hairs to fulfill the requirement of recognizing a working surface of cleaning robots.

Although the disclosure has been explained in relation to its preferred embodiment, it is not used to limit the disclosure. It is to be understood that many other possible modifications and variations can be made by those skilled in the art without departing from the spirit and scope of the disclosure as hereinafter claimed.

1. A cleaning robot, configured to recognize a type of a working surface, and comprising:
a first light source, configured to illuminate the working surface using a main projection light beam to form a main reflected light beam;
a second light source, configured to project a linear light section toward the working surface; and
an image sensor, not arranged on the main reflected light beam, and configured to
receive scattered light of the main projection light beam illuminating the working surface to output a first image frame, and
acquire a second image frame containing a light section image of the linear light section of the second light source.

2. The cleaning robot as claimed in claim 1, further comprising:
a substrate, on which the second light source and the image sensor being arranged; and
a bottom cover, on which the first light source being arranged.

3. The cleaning robot as claimed in claim 2, wherein
the bottom cover comprises a through hole and a bottom surface connecting to the through hole,
the substrate is arranged inside the through hole, and
the first light source is arranged on the bottom surface outside the through hole.

4. The cleaning robot as claimed in claim 1, further comprising a processor configured to
recognize the working surface as a flat floor or a carpet with short hairs according to the first image frame, and
recognize whether the working surface is a carpet with long hairs or not according to the second image frame.

5. The cleaning robot as claimed in claim 4, further comprising memory configured to record a relationship between different positions of the light section image in the second image frame and different distances, wherein
the processor is configured to obtain a current distance from the working surface according to a current position of the light section image in the second image frame and the relationship to identify whether the working surface is the carpet with long hairs.

6. The cleaning robot as claimed in claim 5, wherein the processor is further configured to output the current distance to a micro controller unit of the cleaning robot.

7. The cleaning robot as claimed in claim 4, wherein the processor is configured to
identify the working surface as the carpet with short hairs upon an average brightness of the first image frame exceeding a brightness threshold, and
identify the working surface as the flat floor upon the average brightness of the first image frame being lower than the brightness threshold.

8. A cleaning robot, configured to recognize a type of a working surface, and comprising:
a light source, configured to illuminate the working surface using a main projection light beam to form a main reflected light beam;
an image sensor, not arranged on the main reflected light beam, and configured to receive scattered light of the main projection light beam illuminating the working surface to output an image frame; and
a time-of-flight (ToF) sensor, configured to measure a distant from the working surface.

9. The cleaning robot as claimed in claim 8, further comprising:
a substrate, on which the ToF sensor and the image sensor being arranged; and
a bottom cover, on which the light source being arranged.

10. The cleaning robot as claimed in claim 9, wherein
the bottom cover comprises a through hole and a bottom surface connecting to the through hole,
the substrate is arranged inside the through hole, and
the light source is arranged on the bottom surface outside the through hole.

11. The cleaning robot as claimed in claim 8, further comprising a processor configured to
recognize the working surface as a flat floor or a carpet with short hairs according to the image frame, and
identify the working surface as a carpet with long hairs upon the distance measured by the ToF sensor being smaller than a distance threshold.

12. The cleaning robot as claimed in claim 11, wherein the processor is further configured to output the distance measured by the ToF sensor to a micro controller unit of the cleaning robot.

13. The cleaning robot as claimed in claim 11, wherein the processor is configured to
identify the working surface as the carpet with short hairs upon an average brightness of the first image frame exceeding a brightness threshold, and
identify the working surface as the flat floor upon the average brightness of the first image frame being lower than the brightness threshold.

14. A cleaning robot, configured to recognize a type of a working surface, and comprising:
a first light source, configured to illuminate the working surface using a main projection light beam to form a main reflected light beam;
a reflection surface; and
a second light source, configured to illuminate the reflection surface toward a direction parallel to the working surface; and
an image sensor, not arranged on the main reflected light beam, and configured to
receive scattered light of the main projection light beam illuminating the working surface to output a first image frame, and
receive reflected light of the reflection surface that reflects an emission light beam of the second light source to output a second image frame.

15. The cleaning robot as claimed in claim 7, further comprising:
a bottom cover, comprising a through hole and a bottom surface connecting to the through hole, wherein
the first light source is arranged on the bottom surface outside the through hole,
the second light source is arranged at a first side on an inner wall of the through hole, and
the reflection surface is arranged at a second side, opposite to the first side, on the inner wall of the through hole.

16. The cleaning robot as claimed in claim 15, further comprising:
a substrate, arranged inside the through hole, wherein
the image sensor is arranged on the substrate, but the second light source is not arranged on the substrate.

17. The cleaning robot as claimed in claim 14, further comprising a processor configured to
recognize the working surface as a flat floor or a carpet with short hairs according to the first image frame, and
recognize whether the working surface is a carpet with long hairs or not according to the second image frame.

18. The cleaning robot as claimed in claim 17, wherein the processor is configured to
identify the working surface as the carpet with short hairs upon a first average brightness of the first image frame exceeding a first brightness threshold, and
identify the working surface as the flat floor upon the first average brightness of the first image frame being lower than the first brightness threshold.

19. The cleaning robot as claimed in claim 17, wherein the processor is configured to
identify the working surface as the carpet with long hairs upon a second average brightness of the second image frame being lower than a second brightness threshold.
